(19) United States
(12) Patent Application Publication
(10) Pub. No.: US 2009/0102425 A1
(43) Pub. Date: Apr. 23, 2009

(54) Vehicle-use power supply management apparatus

(75) Inventor: Shin Takahashi, Oobu-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/232,878

(22) Filed: Sep. 25, 2008

(30) Foreign Application Priority Data
Oct. 18, 2007 (JP) 2007-271223

(51) Int. Cl. H02J 7/00

(52) U.S. Cl. 320/136

(57) ABSTRACT

The vehicle-use power supply management apparatus includes a first function of detecting start of any of electrical loads mounted on a vehicle, a second function of detecting a battery voltage, a third function of determining whether or not load restriction should be performed on the basis of the battery voltage detected by the second function, a fourth function of making a determination of whether or not the detected electrical load can be applied with load restriction, and a fifth function of applying load restriction to the detected electrical load if a determination result of the third function and a determination result of the fourth function are affirmative. The third function is configured to make an affirmative determination if a drop of the battery voltage immediately after the start of the detected electrical load is larger than a predetermined value and the duration of the drop exceeds a predetermined time period.

### CROSS-REFERENCE TO RELATED APPLICATION

This application is related to Japanese Patent Application No. 2007-271223 filed on Oct. 18, 2007, the contents of which are hereby incorporated by reference.

### BACKGROUND OF THE INVENTION

1. Field of the Invention

The present invention relates to a vehicle-use power supply management apparatus.

2. Description of Related Art

There is known a vehicle-mounted power supply system having a power supply controller which operates to restrict starting of some electrical loads when the power supply capacity of the system is lower than a predetermined level. For example refer to Japanese Patent Application Laid-open No. 2007-161016. This system is configured to distinguish between a first group of electrical loads which cannot be delayed in start timing, a second group of electrical loads which can be delayed in start timing, and inhibit start of an electrical load of the first group to prevent a plurality of electrical loads from starting at the same time, to thereby suppress drop of a power supply voltage.

However, in the vehicle-mounted power supply system described in the above patent document, if a plurality of electrical loads which cannot be delayed in start timing start at the same time, a large current flows causing the power supply voltage to drop. The power supply controller of the system performs a load restriction upon detecting the voltage drop, as a result of which an engine load is lowered too. Accordingly, when the power supply controller performs the load restriction, the engine may surge up. In addition, since the power supply controller performs the load restriction even when an instantaneous voltage drop occurs due to an inrush current, the frequency with which load restriction is performed may be excessive. Furthermore, since a judgment on whether or not the load restriction should be performed is made on the basis of comparison between a current flowing through a power supply line and a suppliable current, a current sensor is needed. This increases manufacturing costs of the system.

### SUMMARY OF THE INVENTION

The present invention provides a vehicle-use power supply management apparatus comprising:

a first function of detecting start of any of electrical loads mounted on a vehicle and subjected to power supply management;

a second function of detecting a battery voltage;

a third function of determining whether or not load restriction should be performed on the basis of the battery voltage detected by the second function;

a fourth function of making a determination of whether or not the detected electrical load can be applied with load restriction; and

a fifth function of applying load restriction to the detected electrical load if a determination result of the third function and a determination result of the fourth function are both affirmative;

wherein the third function is configured to make an affirmative determination if a drop of the battery voltage immediately after the start of the detected electrical load is larger than a predetermined value and a duration of the drop exceeds a predetermined time period.

According to the present invention, it is possible to provide at low cost a vehicle-use power supply management apparatus able to prevent a frequency with which load restriction is performed from becoming excessive, and accordingly to prevent a frequency with which an engine surges up.

Other advantages and features of the invention will become apparent from the following description including the drawings and claims.

### BRIEF DESCRIPTION OF THE DRAWINGS

In the accompanying drawings:

FIG. 1 is a diagram showing an overall structure of a vehicle-mounted power supply system including a vehicle-use power supply management apparatus according to an embodiment of the invention;

FIG. 2 is a flowchart showing the operation of the vehicle-use power supply management apparatus;

FIG. 3 is a flowchart showing a procedure of load restriction performed by the vehicle-use power supply management

FIG. 4 is a time chart showing an example of variations with time of various signals and voltages in the vehicle-mounted power supply system when the load restriction is not performed;

FIG. 5 is a time chart showing an example of variations with time of various signals and voltages in the vehicle-mounted power supply system when the load restriction is performed; and

FIG. 6 is a diagram showing an overall structure of a vehicle-mounted power supply system including a modification of the vehicle-use power supply management apparatus shown in FIG. 1.

### PREFERRED EMBODIMENTS OF THE INVENTION

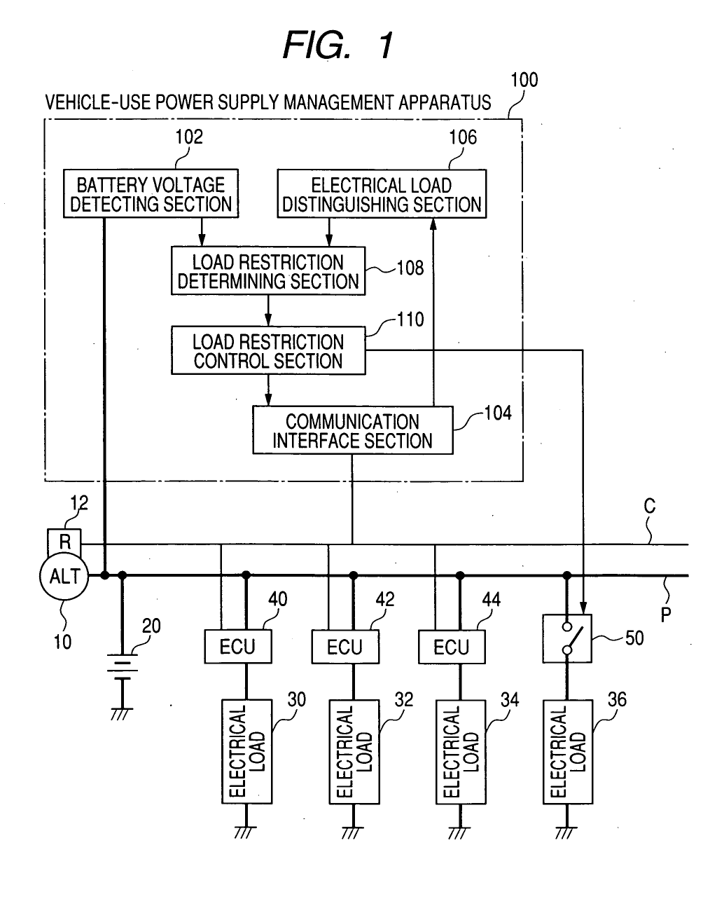

FIG. 1 is a diagram showing an overall structure of a vehicle-mounted power supply system including a vehicle-use power supply management apparatus 100 according to an embodiment of the invention. As shown in FIG. 1, the vehicle-mounted power supply system includes a vehicle alternator 10, a battery 20, electrical loads 30, 32, 34, 36, ECUs (Electronic Control Units) 40, 42, 44, a switch 50, and the vehicle-use power supply management apparatus 100. These components are connected to a power supply line P, and a communication line C.

The alternator 10 is driven by a vehicle engine (not shown) to generate power to be supplied to the electrical loads 30, 32, 34, 36, and to charge the battery 20. The alternator 10 includes a regulator 12. The ECU 40 is for controlling operation of the electrical load 30. The ECU 42 is for controlling operation of the electrical load 32. The ECU 44 is for controlling operation of the electrical load 34. These electrical loads 30, 32, 34 are connected to the power supply line P and the communication line C through the ECUs 40, 42, 44 respectively. The electrical load 36 is connected to the power supply line P through the switch 50. The switch 50 is on/off-controlled directly by the vehicle-use power supply management apparatus 100 without through the communication line C.

The vehicle-use power supply management apparatus 100, which is for performing load restriction to some of the electrical loads, includes a battery voltage detecting section 102, a communication interface section 104, an electrical load distinguishing section 106, a load restriction determining section 108, and a load restriction control section 110.

The battery voltage detecting section 102 detects the terminal voltage of the battery 20. The communication interface section 104, which is for performing a signal input/output control with the communication line C, transmits and receives signals in accordance with a predetermined communication protocol.

Upon detecting through the communication interface section 104 that any one of the electrical loads 30, 32, 34, 36 is started, the electrical load distinguishing section 106 distinguishes whether the started electrical load is a load which can be applied with the load restriction. Since the electrical load 36 is not connected to the communication line C, a signal indicative of the electrical load 36 having been started is inputted to the electrical load distinguishing section 106 directly or through a route different from the communication line C.

In this embodiment, the electrical loads which can be delayed in start timing are defined as electrical loads which can be applied with the load restriction, and the electrical which cannot be delayed in start timing are defined as electrical loads which cannot be applied with the load restriction.

In this embodiment, the electrical loads which can be delayed in start timing are electrical loads which are irrelevant to safe driving of the vehicle provided with this system. For example, they include an electrical motor for driving a pump of the brake system, a fan motor of the air conditioning system of the vehicle. Since the pump of the brake system is a pump operating to keep the pressure of a hydraulic circuit above a predetermined level, no hindrance occurs to safe driving of the vehicle even if the start timing of the pump is delayed.

On the other hand, the electrical loads which cannot be delayed in start timing are electrical loads which are relevant to safe driving of the vehicle, and electrical loads, the operation states of which depend on the driver's or passenger's operation and can be recognized by the driver or passenger. For example, they include an electrical motor of the electric power steering system, an electromagnetic solenoid valve of the brake system, an actuator for adjusting attenuation force of the suspension control system, which are relevant to safe driving of the vehicle, and also include an electrical motor of a power window device, an electrical motor of a windshield wiper device of the vehicle which depend on the driver's or passenger's operation and can be recognized by the driver or passenger.

It is possible to command the three electrical loads 30, 32, 34 of the four electrical loads shown in FIG. 1 to start or stop through the ECUs 40, 42, 44. As for the electrical load 36, it is possible to command it to start or stop by directly on/off controlling the switch 50 without through the communication line C. In this embodiment, all of the four electrical 30, 32, 34 and 36 are electrical loads which can be delayed in start timing. Electrical loads which cannot be delayed in start timing are omitted from being shown.

The load restriction determining section 108 determines whether the load restriction should be performed on the basis of the battery voltage detected by the battery voltage detecting section 102. More specifically, the load restriction determining section 108 determines that the load restriction should be performed if a voltage drop detected by the battery voltage detecting section 102 due to an inrush current is larger than a predetermined value, and duration of the voltage drop is longer than a predetermined time period.

When the load restriction determining section 108 determines that the load restriction should be performed, the load restriction control section 110 designates the electrical load which should be applied with the load restriction.

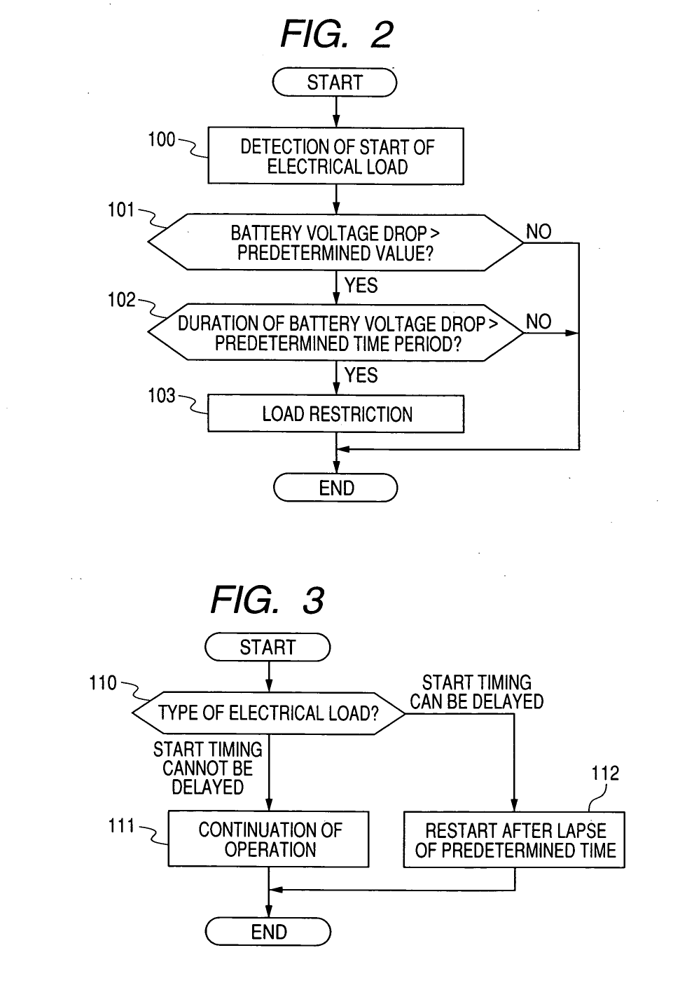

Next, the operation of the vehicle-use power supply management apparatus 100 included in the vehicle-mounted power supply system having the above described structure is explained with reference to the flowchart shown in FIG. 2.

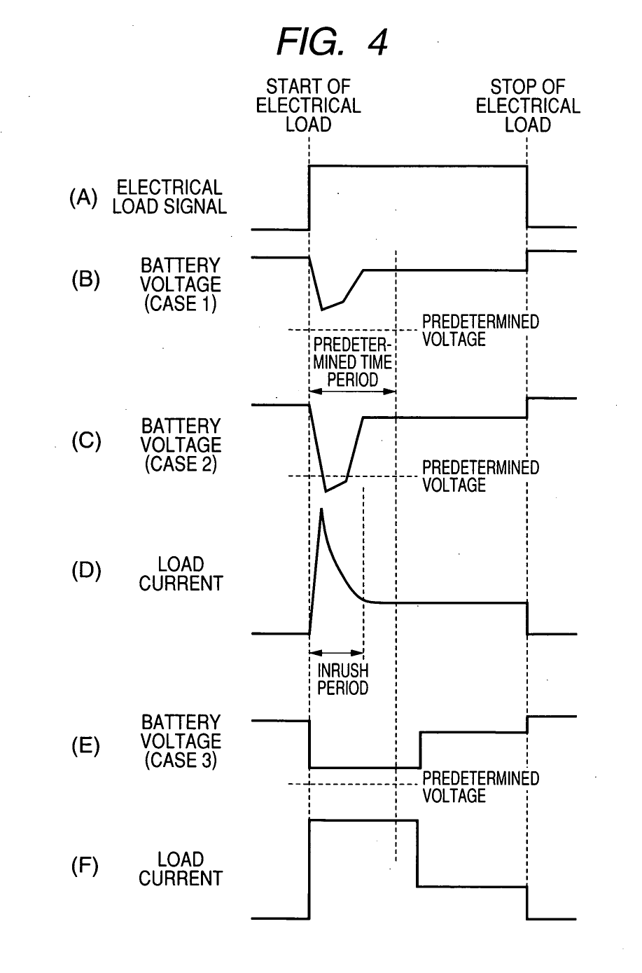

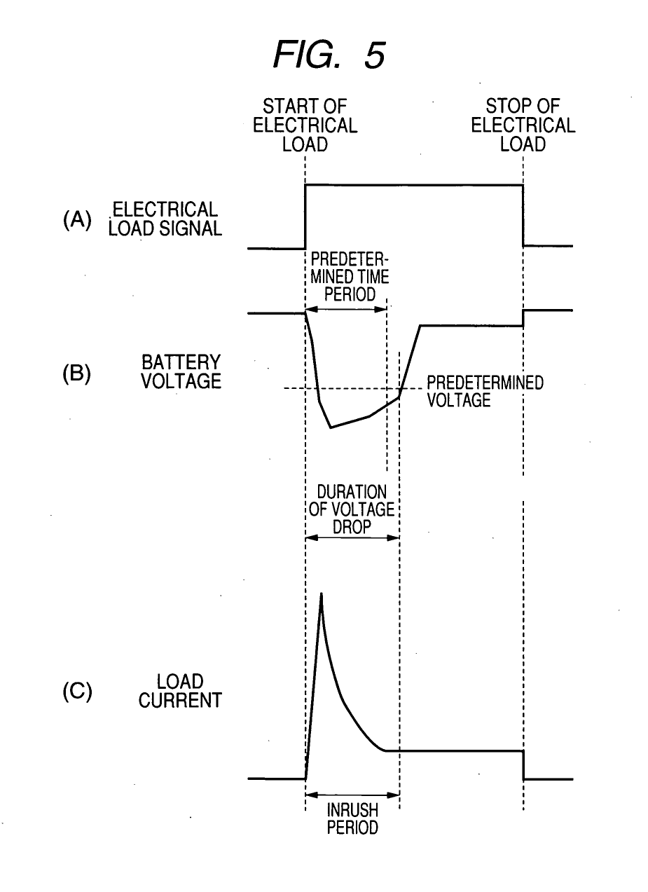

When any of the electrical loads of the vehicle is started, it is detected by the electrical load distinguishing section 106 at step S100. At following step S101, the load restriction determining section 108 determines whether or not a voltage drop detected by the battery voltage detecting section 102 due to an inrush current is larger than the predetermined value. This determination is made by checking whether or not the battery voltage after the start of the electrical load is lower than the battery voltage before the start of the electrical load less a predetermined voltage (“PREDETERMINED VOLTAGE” shown in FIGS. 4 and 5 explained later). If the check result is negative, that is, if the voltage drop is smaller than the predetermined value, a negative determination is made at step S101. In this case, the operation is terminated without performing the load restriction, and as a result, the electrical load having been started is kept in its operating state.

On the other hand, if the check result is affirmative, that is, if the voltage drop is larger than the predetermined value, an affirmative determination is made at step S101. Subsequently, the load restriction determining section 108 determines whether or not the duration of the voltage drop is longer than the predetermined time period at step S102. If the determination result at step S102 is negative, the operation is terminated without performing the load restriction, and as a result, the electrical load having been started is kept in its operating state.

If the determination result at step S102 is affirmative, the load restriction control section 110 applies, at step S103, the load restriction to the electrical load having been started, and then this procedure is terminated.

FIG. 3 is a flowchart showing a procedure of the load restriction. To start the load restriction, the load restriction control section 110 distinguishes at step S110 the type of the electrical load having been started. If the electrical load having been started is of the type that cannot be delayed in start timing, the restriction control section 110 allows the electrical load to continue to be in its start operation at step S111.

On the other hand, if the electrical load having been started is of the type that can be delayed in start timing, the load restriction control section 110 suspends the starting operation of this electrical load at step S112. More specifically, if the electrical load having been started is one of the electrical loads 30, 32 and 34, the load restriction control section 110 sends to a corresponding one of the ECUs 40, 42, and 44 a command directing the electrical load to suspend the start, and make a restart after a lapse of a predetermined time period. If the electrical load having been started is the electrical load 36, the load restriction control section 110 switches the switch 50 to an off state to stop the operation of the electrical load 36, and after a lapse of the predetermined time period, switches the switch 50 to an on state to restart the electrical load 36.

FIG. 4 is a time chart showing an example of variations with time of some of various signals, currents and voltages in the vehicle-mounted power supply system when the load restriction is not performed. The term “electrical load signal” shown in (A) of FIG. 4 means a command signal directing, when it is at high level, the electrical load (one of the electrical loads of the vehicle) to operate. The term “load current” shown in (D) and (F) of FIG. 4 means a current flowing through the electrical load, including an inrush current of the electrical load, and a lock current of a motor as the electrical load. In this example, if the battery voltage drop with the start of the electrical load is small, and accordingly, the battery voltage is kept above the predetermined voltage as shown in (B) of FIG. 4 (case 1), since a negative determination is made at step S101 in FIG. 2, the load restriction is not performed.

Even if the battery voltage drop is large due to an inrush current occurring at the time of the start of the electrical load, and accordingly, the battery voltage drops below the predetermined voltage as shown in (C) of FIG. 4 (case 2), if the duration of the voltage drop is not longer than the predetermined time period as shown in (D) of FIG. 4, since a negative determination is made at step S102 in FIG. 2, the load restriction is not performed.

Likewise, even if the duration of the battery voltage drop is longer than the predetermined time period due to a starting current of the electrical load flowing for a long time as shown in (E) of FIG. 4 (case 3), if the battery voltage is kept above the predetermined voltage, since a negative determination is made at step S101 in FIG. 2, the load restriction is not performed.

FIG. 5 is a time chart showing an example of variations with time of some of various signals, currents and voltages in the vehicle-mounted power supply system when the load restriction is performed. As shown in FIG. 5, if the battery voltage drops below the predetermined voltage, and the duration of the voltage drop exceeds the predetermined time period due to a large inrush current occurring at the time of start of the electrical load, since an affirmative determination is made at each of steps S101 and S102, the load restriction is performed. In FIG. 5, the variation with time of the battery voltage is shown assuming that the electrical load having been started continues its operation. However, actually, the battery voltage rises above the curve shown in (B) of FIG. 5 at the timing when the duration of the battery voltage drop exceeds the predetermined time period, because the load restriction starts at this timing. In the examples shown in FIGS. 4 and 5, it is assumed that the start time of the duration period of the battery voltage drop is the time when the electrical load is started, however, the start time may be assumed to be the time when the battery voltage drops below the predetermined voltage.

As explained above, the vehicle-use power supply management apparatus 100 does not perform the load restriction even when an inrush current occurs if it disappears in a short time. Hence, according to this embodiment, it is possible to prevent the frequency with which the load restriction is performed from becoming excessive, and accordingly, to prevent the frequency with which the engine surges up due to lowering of the engine load. It is needless to say that malfunction of the electrical loads or a system down can be prevented from occurring by keeping the battery voltage above a predetermined value by performing the load restriction. Furthermore, since the vehicle-use power supply management apparatus determines the necessity of the load restriction not on the basis of the current flowing through the power supply line, but on the basis of the battery voltage, any specific current sensor is not required. This makes it possible to reduce the manufacturing costs of the system.

In this embodiment, the electrical loads which are irrelevant to safe driving of the vehicle are defined as electrical loads which can be delayed in start timing, while on the other hand, the electrical loads which are relevant to safe driving of the vehicle are defined as electrical loads which cannot be delayed in start timing and electrical loads which depend on the driver's or passenger's operation and can be recognized by the driver or passenger are defined as electrical loads which cannot be delayed in start timing. This makes it possible to ensure safe vehicle driving, and to prevent the driver's or passenger's operability of electrical or electronic devices mounted on the vehicle from being degraded.

By sending a direction to perform the load restriction to the corresponding ECU in the form of a command signal through the communication line, the direction can have resistivity to external noise and accordingly can be reliably implemented. On the other hand, by directly on/off controlling the switch 50 to perform the load restriction, it is possible to simplify the structure of the vehicle-use power supply management apparatus 100, and reduce the manufacturing costs thereof.

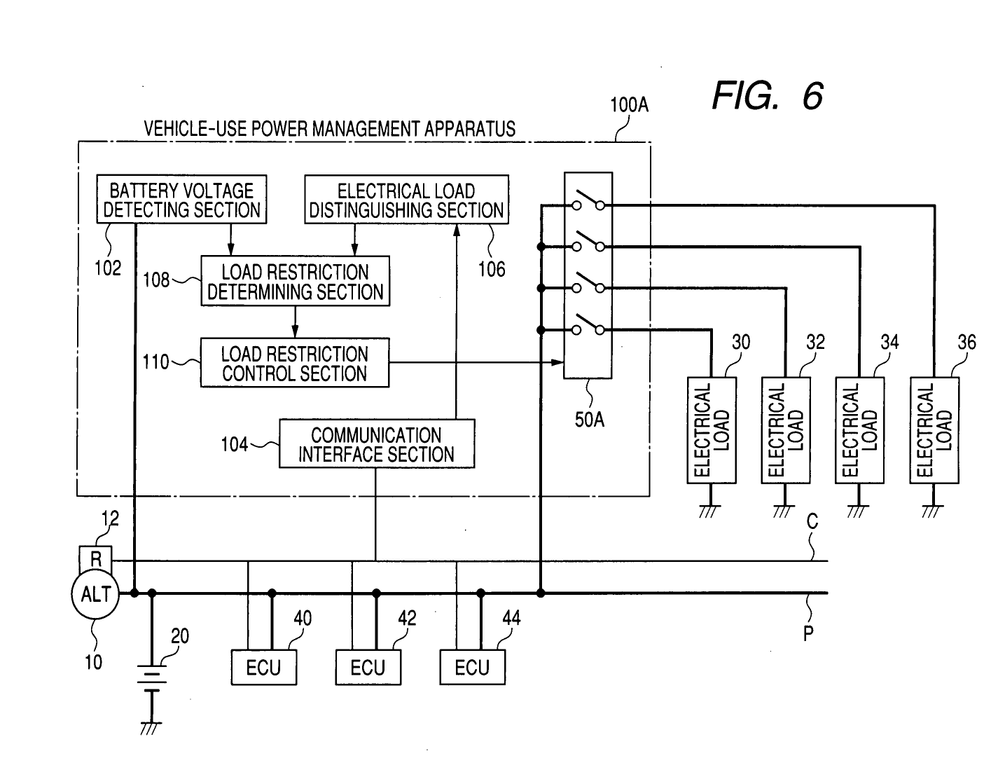

FIG. 6 is a diagram showing an overall structure of a vehicle-mounted power supply system including a vehicle-use power supply management apparatus 100A as a modification of the vehicle-use power supply management apparatus 100 shown in FIG. 1. The vehicle-use power supply management apparatus 100A differs from the vehicle-use power supply management apparatus 100 shown in FIG. 1 in that it includes a switch circuit 50A for respectively on/off controlling connections between the electrical loads 30, 32, 34, 36 and the power supply line P. Although the switch circuit 50A is shown to be located inside the vehicle-use power supply management apparatus 100A, it may be located outside the vehicle-use power supply management apparatus 100A. Using such a switch circuit 50A makes it possible that a plurality of switches can be cooled as a group to thereby improve cooling efficiency and reduce the manufacturing costs.

The above explained preferred embodiments-are exemplary of the invention of the present application which is described solely by the claims appended below. It should be understood that modifications of the preferred embodiments may be made as would occur to one of skill in the art.

What is claimed is:

1. A vehicle-use power supply management apparatus comprising:
a first function of detecting start of any of electrical loads mounted on a vehicle and subjected-to power supply management;
a second function of detecting a battery voltage;
a third function of determining whether or not load restriction should be performed on the basis of the battery voltage detected by the second function;
a fourth function of making a determination of whether or not the detected electrical load can be applied with load restriction; and
a fifth function of applying load restriction to the detected electrical load if a determination result of the third function and a determination result of the fourth function are both affirmative;
wherein the third function is configured to make an affirmative determination if a drop of the battery voltage immediately after the start of the detected electrical load is larger than a predetermined value and a duration of the drop exceeds a predetermined time period.

2. The vehicle-use power supply management apparatus according to claim 1, wherein the fifth function is configured to send a direction to perform load restriction to an ECU controlling the detected electrical load through communication to apply load restriction to the detected electrical load.

3. The vehicle-use power supply management apparatus according to claim 1, wherein the fifth function is configured to on/off controlling a switch connected between a power supply line of the vehicle and the detected electric load to apply load restriction to the detected electrical load.

4. The vehicle-use power supply management apparatus according to claim 1, wherein the vehicle includes a first electrical load controlled by an ECU connected to a communication line of the vehicle and a second electrical load connected to a power supply line of the vehicle through a switch, the vehicle-use power supply management apparatus being configured to send a direction to perform load restriction to the ECU through the communication line to apply load restriction to the first electrical load, and turn off the switch to apply load restriction to the second electrical load.

5. The vehicle-use power supply management apparatus according to claim 1, wherein the electrical loads are connected to a power supply line of the vehicle respectively through a corresponding one of a plurality of switches, the plurality of the switches being constituted as a collective switch.

6. The vehicle-use power supply management apparatus according to claim 1, wherein the fourth function includes a sixth function of distinguishing whether the detected electrical load is of a first type which can be delayed in start timing, or of a second type which cannot be delayed in start timing, the fourth function being configured to make an affirmative determination if the detected electrical load is of the first type, the fifth function being configured to suspend the start of the detected electrical load and restart the detected electrical load after a lapse of a predetermined time when the determination results of the third and fourth function are affirmative.

7. The vehicle-use power supply management apparatus according to claim 6, wherein the first type of electrical loads include electrical loads irrelevant to safe driving of the vehicle, and the second type of electrical loads include electrical loads relevant to safe driving of the vehicle and electrical loads operation states of which depend on driver's or passenger's operation and can be recognized by the driver or passenger.
